(19) United States
(12) Patent Application Publication
(10) Pub. No.: US 2026/0233662 A1
(43) Pub. Date: Aug. 13, 2026

(54) LOCKING ADAPTER FOR S-HOOKS

(71) Applicant: Steven Kowalcyk, Mission Viejo, CA (US)

(72) Inventor: Steven Kowalcyk, Mission Viejo, CA (US)

(21) Appl. No.: 19/405,567

(22) Filed: Dec. 2, 2025

Related U.S. Application Data
(60) Provisional application No. 63/755,982, filed on Feb. 7, 2025.

(51) Int. Cl. B60P 7/08

(52) U.S. Cl. CPC B60P 7/0807; B60P 7/0823

(57) ABSTRACT

A locking adapter for use with an S-hook can be used to convert an open S-hook into a locking S-hook. A spring-loaded latch is biased to rest against a free end of the S-hook, forming a closed loop with the free end of the S-hook. The S-hook can be opened by pressing the latch away from the free end of the S-hook. The adapter may be secured to the S-hook with a bottom locking mechanism. The adapter may be used with different sizes of S-hooks by using latches of different sizes with the adapter body.

### CROSS-REFERENCE TO RELATED APPLICATIONS

This application claims the benefit of U.S. Provisional Application No. 63/755,982, filed Feb. 7, 2025, which is hereby incorporated by reference, to the extent that it is not conflicting with the present application.

### BACKGROUND OF INVENTION

### 1. Field of the Invention

The invention relates generally to hooks, latches, and connectors, and more specifically to latching and locking hooks for use with load tie-downs and securing straps.

### 2. Description of the Related Art

Generally, S-hooks that are provided on the ends of tie-down straps for loads on trucks and other such vehicles are open and do not have a locking mechanism. This can provide a simple way to latch an S-hook onto a desired point, but the lack of a locking mechanism can cause the S-hook to fall off and not be secured to a fixed point. Furthermore, a user may have to hold the tie-down strap taut during the process of securing a load so that the S-hook does not fall down. Therefore, there is a need for a solution to the above problems.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, provided herein are adapters for S-hooks, having a latch mechanism with a lock to secure the S-hook to a fixed point. In some embodiments, the locking bar of the adapter stays in a locked position via a spring-loaded mechanism by being biased to be in the closed or locked position, thus providing the advantage of preventing the S-hook from slipping off the fixed point.

In another aspect, the adapter is provided with a bottom lock for securing the adapter to an S-hook. The bottom lock may include a fastener such as a nut and bolt raised edges to lock in the adapter to the S-hook, in addition the spring-loaded latch or bar, thus providing a more secure attachment to the S-hook.

In another aspect, the locking adapters disclosed herein are configured to fit onto existing S-hooks, thus providing the advantage of converting an open S-hook to an S-hook with a locking mechanism.

In another aspect, the locking adapters may be provided in various dimensions, thus providing options for using with a variety of existing S-hooks.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIGS. 1A-1B illustrate a side perspective view and a top view, respectively, of a locking adapter for an S-hook, according to an aspect.

FIG. 2A illustrates a top view of a locking adapter for an S-hook, shown with a longer pin/shaft for the purpose of clarity, according to an aspect.

FIGS. 2B-2E illustrate components of the latching mechanism of a locking adapter for an S-hook, according to an aspect.

FIGS. 3A-3F illustrate a top view, bottom view, front view, back view, left side view, and right side view, respectively, of a locking adapter for an S-hook, according to an aspect.

FIGS. 4A-4D illustrate a side view, top view, front view, and back view, respectively, of a latch of a locking adapter for an S-hook, according to an aspect.

FIGS. 5A-5B illustrate side views of a first example and a second example of locking adapters installed onto a first type of S-hook and a second type of S-hook, according to an aspect.

FIG. 5C illustrates a back perspective view of a locking adapter installed onto an S-hook with a strap installed on the lower loop of the S-hook, according to an aspect.

FIG. 6 illustrates a side view of a locking adapter for an S-hook installed onto an S-hook, according to an aspect.

FIG. 7 illustrates a left side view of a locking adapter for an S-hook, wherein the locking adapter comprises an additional lock, according to an aspect.

FIG. 8 illustrates a right side view of a locking adapter for an S-hook, wherein the locking adapter comprises an additional lock, according to an aspect.

FIG. 9 illustrates a perspective view of a locking adapter for an S-hook installed onto an S-hook, according to an aspect.

FIG. 10 illustrates a detail view of a locking adapter for an S-hook, showing a molded holder on a side wall, according to an aspect.

FIGS. 11A-11D illustrate a top view, left side view, front view, and right side view, respectively, of a locking adapter for an S-hook, according to an aspect.

FIG. 11E illustrates a cross-sectional view A-A through a locking adapter for an S-hook, according to an aspect.

FIG. 11F illustrates a cross-sectional view B-B through a locking adapter for an S-hook, according to an aspect.

FIGS. 12A-12C illustrate a bottom view, a side view, and a top view, respectively, of a latch component of a locking adapter for an S-hook, according to an aspect.

FIGS. 13A-13B illustrate a side view and an end view, respectively, of a pin that pivotally attaches a latch to a body of a locking adapter for an S-hook, according to an aspect.

FIGS. 14A-14C illustrate a perspective view, a side view, and a front view, respectively, of a spring component of a locking adapter for an S-hook, according to an aspect.

FIGS. 15A-15C illustrate the assembly of a locking adapter for an S-hook, according to an aspect.

FIGS. 16A-16D illustrate a bottom view, a side view, a top view, and a front view, respectively, of a long latch component of a locking adapter for an S-hook, according to an aspect.

FIGS. 17A-17C illustrate the assembly of a locking adapter for an S-hook, wherein the locking adapter comprises a long latch, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

It should be understood that, if dimensions are shown in a figure, they are shown as an example, and the invention is not limited to such dimensions.

For the following description, it can be assumed that most correspondingly labeled elements across the figures (e.g., 101 and 201, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

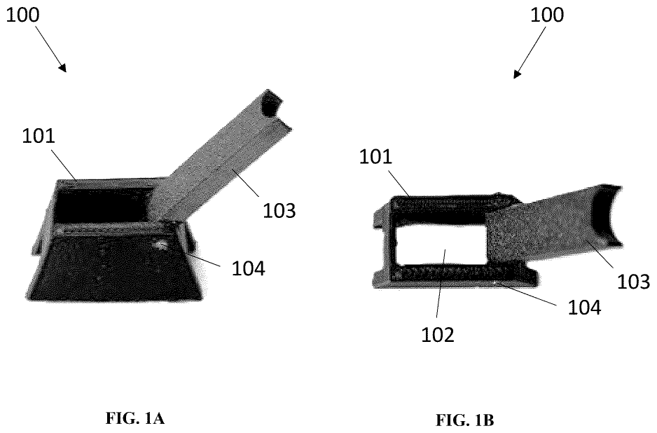

FIGS. 1A-1B illustrate an example of a locking adapter 100 for an S-hook, according to an aspect. Generally, the locking adapters 100 disclosed herein may comprise a trapezoidal prism shaped adapter body 101 and may be provided with a central hole or opening 102 for receiving an S-hook and a hinged latch 103. The trapezoidal prism shape allows the adapter body 101 to be easily passed over the middle of the S-hook and conform to the bottom portion of the S-hook, as described below. The latch 103 may have a flat rectangular shape and may be pivotally connected to the adapter body 101. In an embodiment, the pivotal or hinge connection may be provided by a shaft or pin 104. It should be understood that, generally, the locking adapters disclosed herein could be provided to be used on any existing S-hook. Generally, the locking adapters disclosed herein could be provided with various dimensions in order to fit various types of existing S-hooks. The adapter body 101 and latch 103 may be constructed of PC-ABS resin blend or other polymer materials, with UV resistance additives.

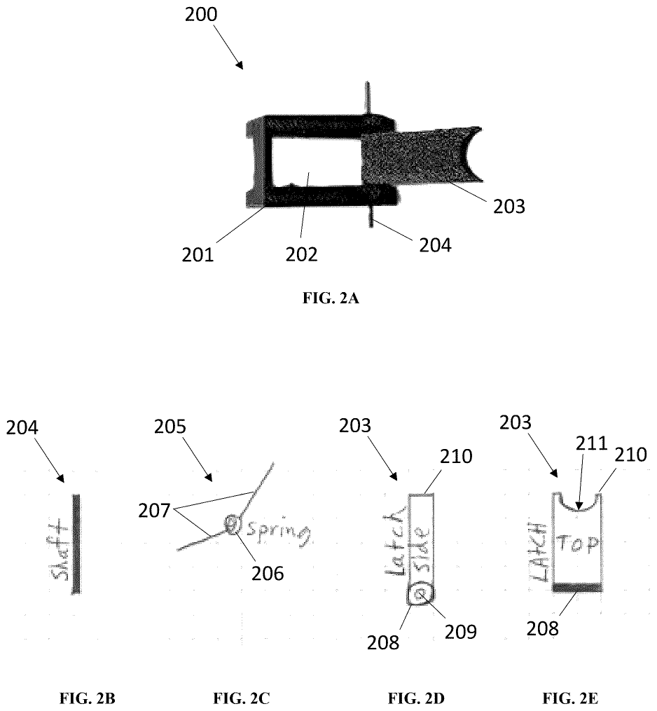

FIGS. 2A-2E provide illustrations of the details of a locking adapter 200 for an S-hook, according to an aspect. For purposes of illustration, a long pin 204 is shown in FIG. 2A to clarify the position of the pin 204 relative to a latch 203 and adapter body 201, but in preferred embodiments the ends of the pin 204 do not protrude beyond the surface of the adapter body 201. FIG. 2B depicts a shaft or pin 204 that pivotally connects the latch 203 to the adapter body 201. FIG. 2C depicts a spring 205, which may be a helical torsion spring, comprising a spring coil 206 and spring legs 207 for biasing the latch in a desired position. In an embodiment, one spring leg 207 may rest against a surface of the adapter body 201, and another spring leg 207 may press against a latch 203. FIGS. 2D-2E depict a side view and a top view, respectively, of a latch 203 used for creating a lock on an S-hook. The latch 203 comprises a latch pivot end 208 having a latch pinhole 209, as seen in FIG. 2D, configured to hold the pin 204, and a latch free end 210 having a curved cut-out edge 211 configured to securely rest against an S-hook and prevent slipping.

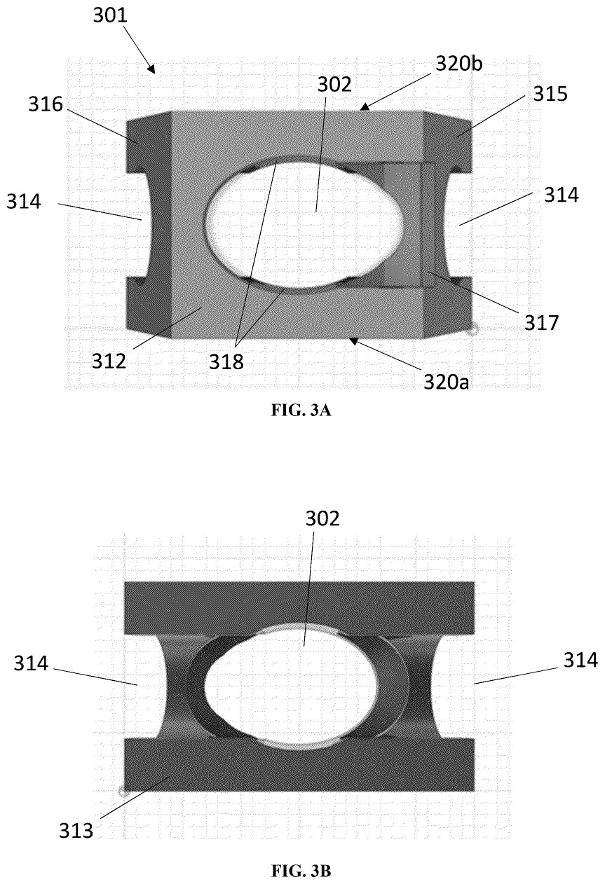

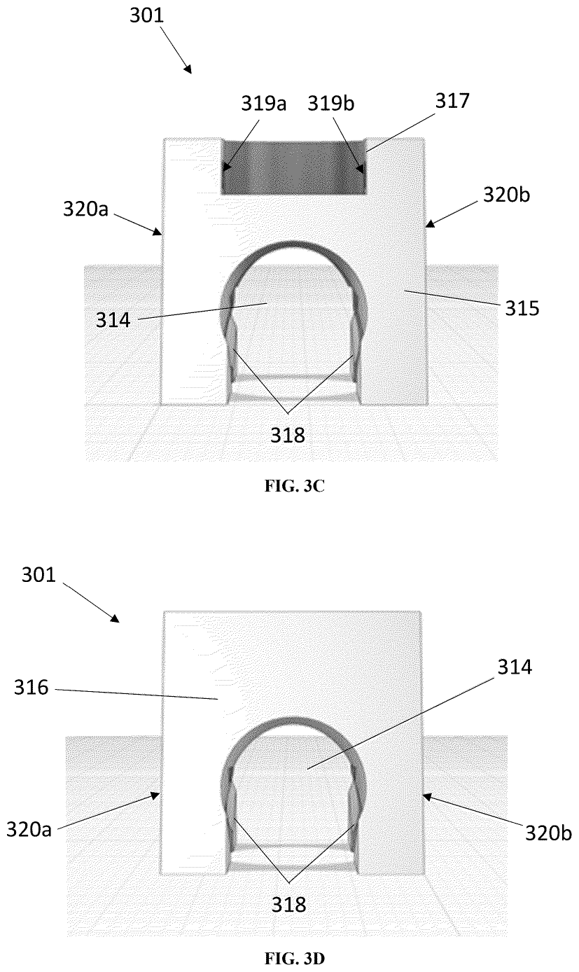

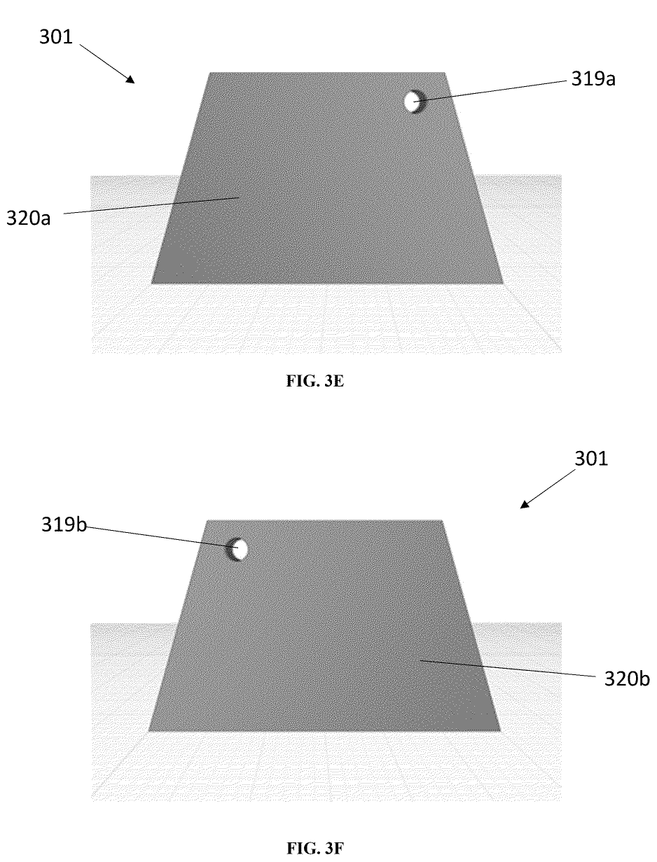

FIGS. 3A-3F depict a top plan view, a bottom plan view, a front view, a back view, a left side view, and a right side view, respectively, of an adapter body 301 of a locking adapter for an S-hook, without an attached latch, according to an aspect. In an embodiment, as seen in FIGS. 3A-3B, the adapter body 301 comprises a central opening 302 through the center of the adapter body 301 from an adapter body top wall 312 to an adapter body bottom wall 313. A side channel 314 passes through the body 301 from a front body wall 315 of the adapter body 301 to a back body wall 316, and the side channel 314 is open along the bottom body wall 313 of the adapter body 301. The curved shape of the side channel helps the adapter body 301 to conform to and secure to the S-hook. As seen in FIG. 3C, a cut-out 317 in the front body wall 315 of the adapter body 301 accommodates a pivot end of a latch, such as the latch pivot end 208 of latch 203 in FIG. 2A, and also acts as a stopper to limit the range of motion of the latch. FIGS. 3C-3D also show raised ridges 318 on the interior surface of the adapter body 301 that form a bottom locking structure to help secure the adapter body 301 to an S-hook. As seen in FIGS. 3C & 3E-3F, a left side pinhole 319a passes through the left side wall 320a and a right side pinhole 319b passes through a right side wall 320b, wherein the left side pinhole 319a and right side pinhole 319b are configured to hold the ends of a pin, such as pin 204 seen in FIGS. 2A-2B, for securing a latch, such as latch 203 seen in FIGS. 2A & 2D-2E, to the adapter body 301.

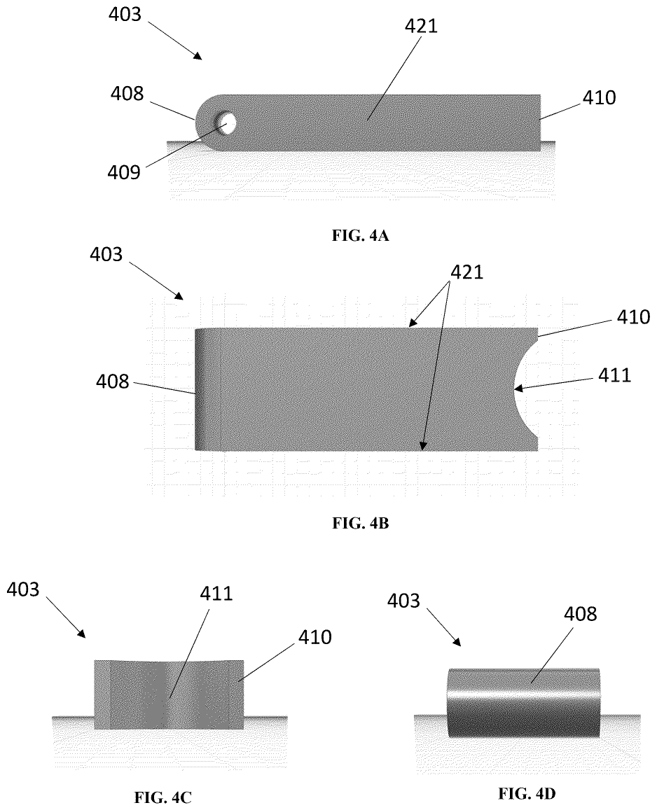

FIGS. 4A-4D depict a side view, top view, front view, and back view, respectively, of a latch 403. As seen in FIG. 4A, a latch pinhole 409 is configured to hold a pin, such as pin 204, for securing the latch 403 to a body of a locking adapter, such as adapter body 301 in FIGS. 3A-3F. The latch pinhole 409 is located at a latch pivot end 408 of the latch 403 and has openings in the latch side walls 421 of the latch 403. As seen in FIGS. 4B-4C, a latch free end 410 of the latch 403 comprises a concave curved cut-out edge 411 that allows the latch 403 to hold securely against the S-hook. As seen in FIGS. 4A & 4D, the latch pivot end 408 is curved to allow the latch 403 to rotate within a cut-out in a front body wall of an adapter body, such as cut-out 317 in a front body wall 315 of adapter body 301 (see FIGS. 3A & 3C).

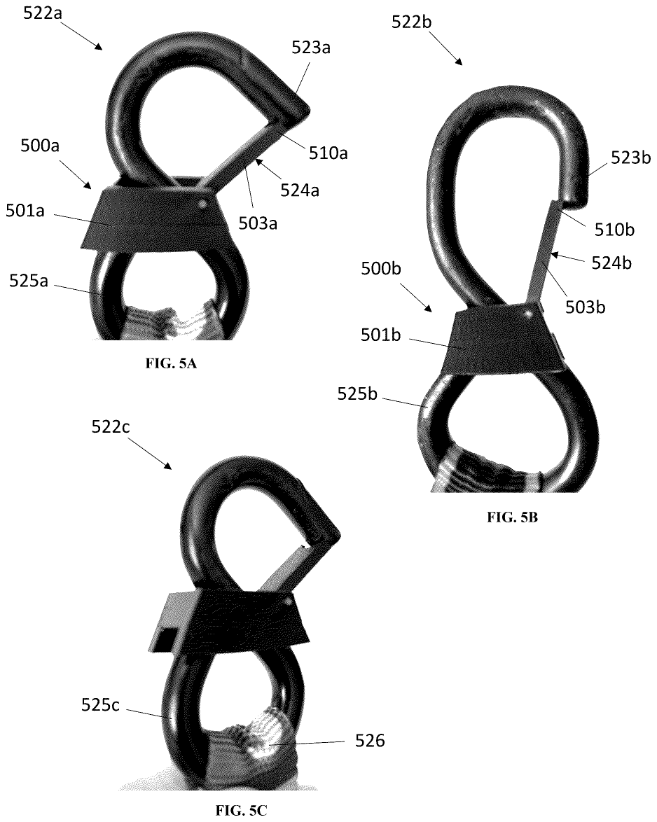

FIGS. 5A-5B depict a first example and a second example of locking adapters installed onto a first type and a second type of S-hook, according to an aspect. S-hooks may be provided in various sizes and dimensions. Accordingly, locking adapters can be provided with different dimensions such as different lengths, heights, and widths in order to fit certain S-hooks. For example, a first example of a locking adapter 500a is sized to fit onto an S-hook 522a, which has a generally shorter and wider shape, while a second example of a locking adapter 500b is sized to fit onto an S-hook 522b, which has a generally taller and narrower shape. Each locking adapter 500a, 500b may be fitted onto an S-hook 522a, 522b by threading the central passage of the adapter, such as the central passage 102 of the adapter 100 shown in FIG. 1B, over a free end 523a, 523b of the S-hook 522a, 522b and passing the S-hook 522a, 522b through the central passage of the adapter 522a, 522b until it sits at a midpoint of the S-hook 522a, 522b. The trapezoidal shape of the adapter body 501a, 501b provides a wider bottom portion, allowing the adapter body 501a, 501b to more easily pass over the middle of the S-hook and the conform to the shape of a bottom portion 525a, 525b of the S-hook 522a, 522b. The greater contact area at the bottom of the adapter body 501a, 501b provides a more secure contact by raised ridges, such as the raised ridges 318 of adapter body 301 described above, helping to hold the adapter 500a, 500b in place.

As can be seen in the examples depicted in FIGS. 5A-5B, the latch free end 510a, 510b of latch 503a, 503b of the locking adapter 500a, 500b may be biased outward, away from the inside of the S-hook 522a, 522b, to rest against the S-hook free end 523a, 523b of the S-hook 522a, 522b, thereby forming a closed loop. The latch free end 510a, 510b of the latch 503a, 503b may be provided with a curved shape, for example to snugly fit against the S-hook. The latch 503a, 503b can be biased into this locked position by a spring, such as spring 205 seen in FIG. 2C, and the closed loop formed by the S-hook free end 523a, 523b and latch 503a, 503b can be opened by applying pressure to a bottom outside latch surface 524a, 524b, such as by manually pressing against the bottom outside latch surface 524a, 524b.

As can be seen in FIG. 5C, in an embodiment, the bottom section 525c, of an S-hook 522c may be a closed loop and may be attached to a tie-down strap 526, which can be used for tying down loads in vehicles, for example.

FIG. 6 illustrates a locking adapter 600 installed on an S-hook, according to an aspect. In an embodiment, the adapter body 601 may comprise an overhanging lip 627 that may act as a stop for spring legs, as described below. A latch 603 is pivotally attached to adapter body 601 by a pin 604 and is biased against a free S-hook end 623 of an S-hook 622.

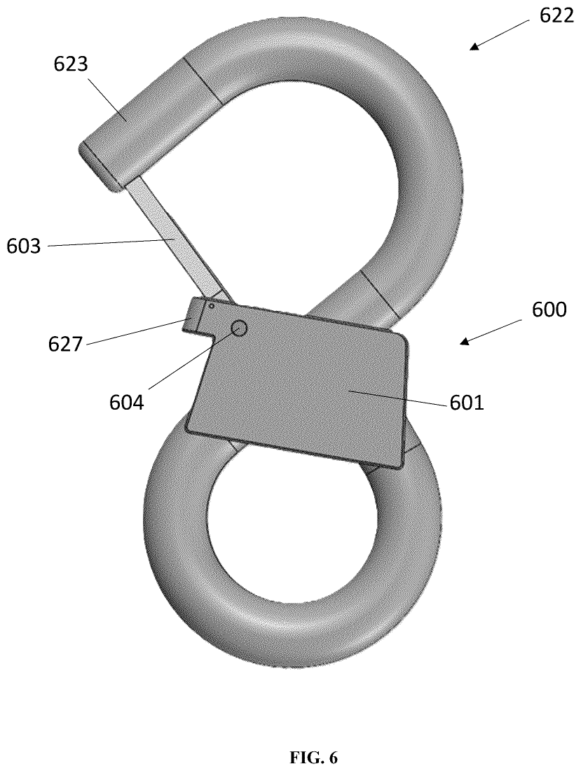

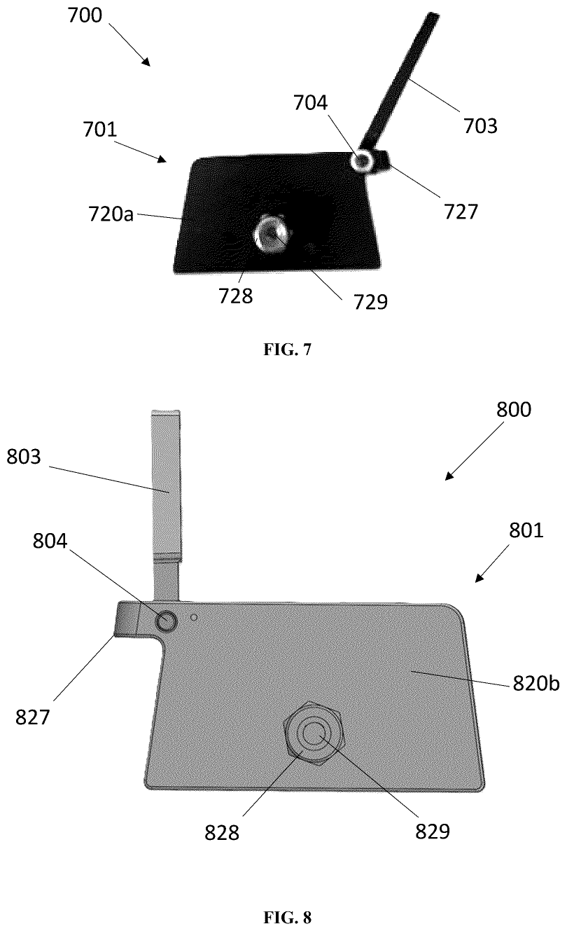

In an embodiment, as seen in FIG. 7, a locking adapter 700 for an S-hook comprises a latch 703 pivotally attached to an adapter body 701 using a pin 704 and may further comprise a bottom locking mechanism comprising a nut 728 and a screw or bolt 729 passing through the adapter body 701 to further lock an S-hook in the adapter 700. The nut 728 may be placed on the left side 720a of the adapter body 701, with the bolt 729 being passed through the adapter body 701 from a right side, or the nut 728 and bolt 729 may be reversed, as seen in FIG. 8. In an embodiment, a locking adapter 800 for an S-hook comprises a latch 803 pivotally attached to an adapter body 801 using a pin 804, and a nut 828 is placed on a right side 820b of an adapter body 801 of a locking adapter 800 and a bolt 829 is passed through the adapter body 801 from a left side of the adapter body. While FIGS. 7 and 8 illustrate a nut 728, 828 and a bolt 729, 829 used as a bottom locking mechanism on an adapter body with a lip 727, 827, a nut and bolt bottom locking mechanism may also be used with other embodiments of the adapter body described herein.

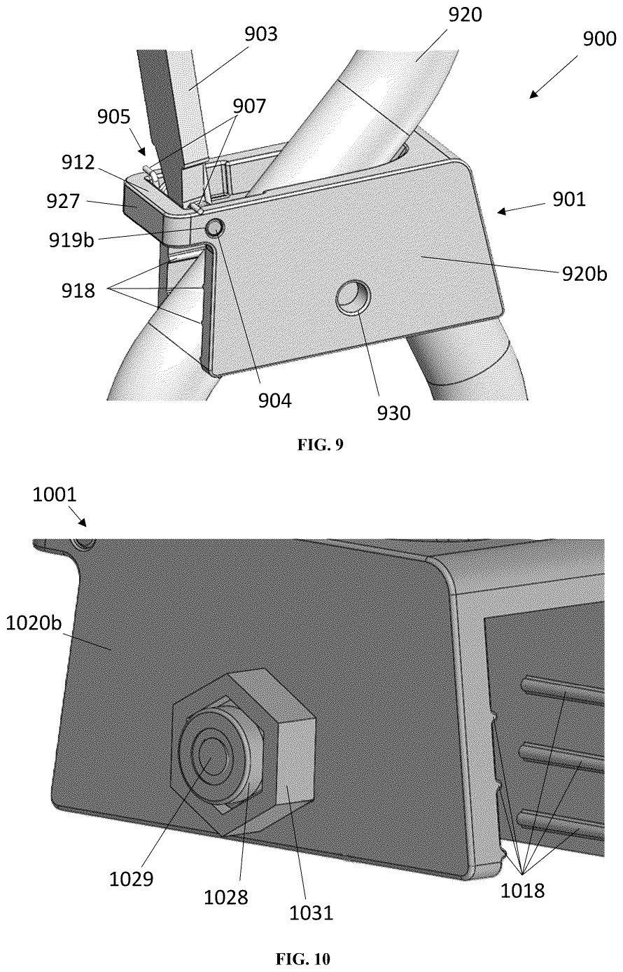

FIG. 9 illustrates a locking adapter 900 for an S-hook, according to an aspect. In an embodiment, the locking adapter 900 comprises a bolt hole 930 in an adapter body 901 for passing a bolt used to lock the locking adapter 900 onto an S-hook 920. The adapter body 901 may also comprise raised ridges 918 on the interior surface of the adapter body 901 that help to secure the adapter 900 to the S-hook 920. According to an aspect, a latch 903 is secured to the adapter body 901 by a pin 904. As seen in FIG. 9, the pin 904 passes through an end of the latch 903, with the ends of the pin 904 secured in a hole in each side wall of the adapter body 901 (right wall 920b and right wall hole 919b are shown in FIG. 9). According to an aspect, a spring 905, which may be a double torsion spring, is configured to bias the latch 903 against a free end of an S-hook 920. In an embodiment, the spring legs 907 may rest under a lip 927 at the front of the adapter body 901, wherein the lip 927 acts as a stopper to secure the spring legs 907 as the spring is angularly displaced and loaded in torsion. In an alternate embodiment, such as shown in FIG. 9, spring legs 907 may rest on the top surface 912 of the adapter body 901.

FIG. 10 illustrates a detail of an adapter body 1001 of a locking adapter for an S-hook, according to an aspect. The adapter body 1001 may comprise a molded holder 1031 for securing a nut 1028, such as a hex locknut, wherein the molded holder 1031 and a side wall of the adapter body 1001, such as right side wall 1020b in FIG. 10, are a monolithic body. In an embodiment, the molded holder 1031 may also instead be located on a left side wall. A screw or bolt 1029 is threaded into the nut 1028, with the molded holder 1031 securing the nut 1028, to lock the body 1001 of the adapter onto an S-hook. Also seen in FIG. 10 are raised ridges 1018 on the interior surface of the walls of the adapter body 1001 which help to secure the adapter onto an S-hook, according to an aspect.

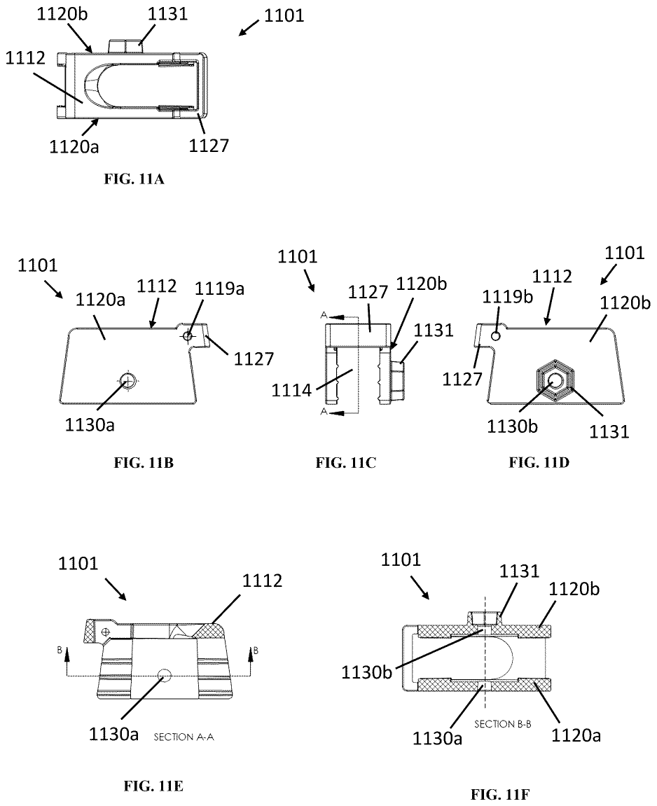

FIGS. 11A-11F illustrate views of an adapter body 1101 of a locking adapter for an S-hook, according to an aspect. FIG. 11A is a top view of an adapter body 1101 comprising a lip 1127 at a front end and a molded holder 1131 on the right side 1120b of the adapter body. FIG. 11B is a left side view of the adapter body 1101 showing a hole 1130a in the left side 1120a for passing a bolt and a smaller hole 1119a for holding an end of a pin near the lip 1127. FIG. 11C is a front view of the adapter body 1101 showing the molded holder 1131 on the right side 1120b of the adapter body 1101 and a side channel 1114 that is more open than the side channel 314 in the adapter body embodiment 301 described above and seen in FIGS. 3A-3D. In an embodiment, a more open side channel 1114 allows the adapter body 1101 to be used with a wider variety of S-hooks of various sizes and shapes, providing a locking adapter with a universal fit. FIG. 11D is a right side view of the adapter body 1101 showing the molded holder 1131, a hole 1130a for passing the end of a screw, and a smaller hole 1119b for holding an end of a pin. FIG. 11E is a section view through the top body wall 1112 of the adapter body 1101, indicated as Section A-A in FIG. 11C, looking toward the left side of the adapter body 1101 from the center of the adapter body 1101. FIG. 11F is a section view through the adapter body 1101, indicated as Section B-B in FIG. 11E, through the molded holder 1131 and looking toward the top 1112 of the adapter body 1101.

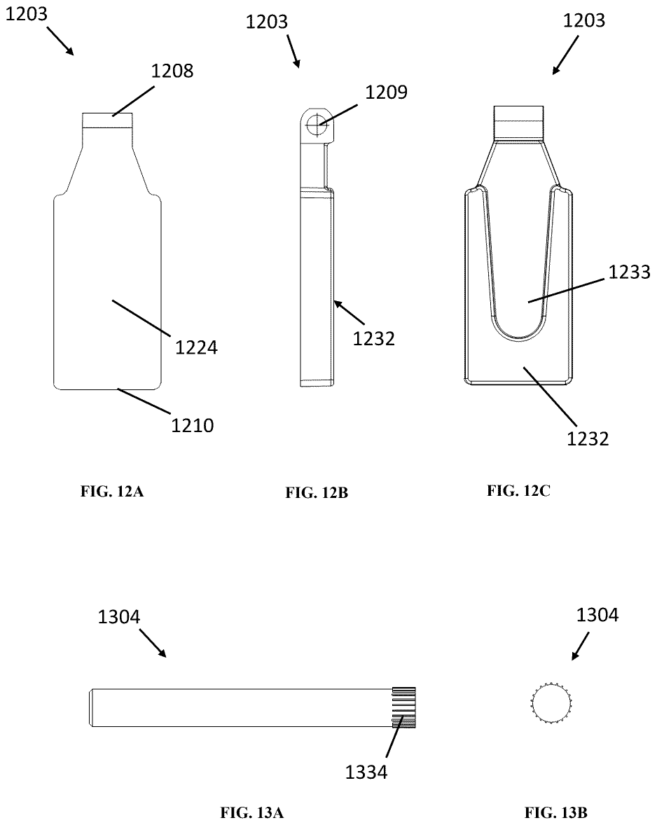

FIGS. 12A-12C illustrate views of an example of a short latch 1203 of a locking adapter for an S-hook, according to an aspect. FIG. 12A is a bottom view of the short latch 1203 showing a latch bottom surface 1224 and indicating a latch pivot end 1208 (comprising a latch hole 1209 seen in FIG. 12B) and a latch free end 1210 which rests against a free S-hook end of an S-hook. In an embodiment, the latch free end 1210 could also comprise a concave curved surface (not shown), as described above and shown in FIGS. 4B-4C for the latch 403 comprising concave curved edge 411. FIG. 12B is a side view of the short latch 1203 showing the latch hole 1209 for holding a pin which secures the short latch 1203 to an adapter body. FIG. 12C is a top view of the short latch 1203 showing a top notch 1233 formed in the top latch surface 1232 of the short latch 1203. The top notch 1233 is configured to hold and secure a spring arm, as described below.

FIGS. 13A-13B illustrate views of a pin 1304 of a locking adapter for an S-hook, according to an aspect. FIG. 13A is a side view of the pin 1304 showing a knurled end 1334, which provides a friction fit when inserting the pin 1304 within a pin hole of a side wall of an adapter body, securing the pin 1304 in place. FIG. 13B is an end view of the pin 1304.

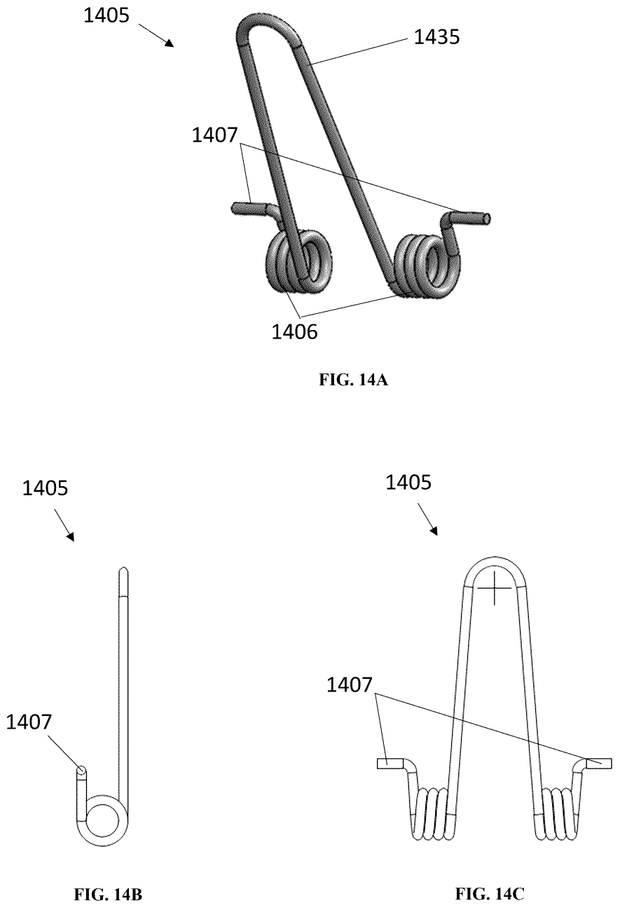

FIGS. 14A-14C illustrate a perspective view, a side view, and a front view, respectively, of a spring 1405 of a locking adapter for an S-hook, which may be a double torsion spring, according to an aspect. In an embodiment, a spring 1405 comprises spring legs 1407, spring coils 1406, and a central spring arm 1435. The spring legs 1407 may be secured on the top surface of an adapter body, as described above, or under a lip of an adapter body, as described below, and the central spring arm 1435 presses against a latch of a locking adapter to bias the latch when the spring 1405 is angularly displaced and loaded.

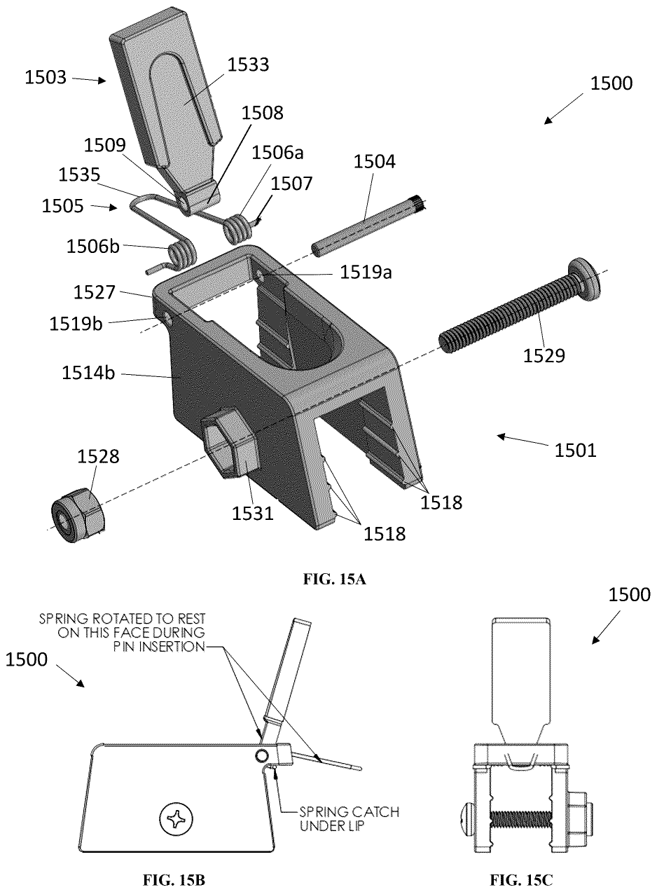

FIGS. 15A-15C illustrate the assembly of a locking adapter 1500, according to an aspect. FIG. 15A illustrates an exploded view of the locking adapter 1500 showing the assembly of the locking adapter 1500, and FIGS. 15B-15C illustrate the rotation of the central spring arm 1535 during pin insertion such that the central spring arm 1535 rests in a latch top notch 1533 of a latch 1503 after assembly of the locking adapter 1500. In an embodiment, a latch 1503 is secured to an adapter body 1501 by passing a pin 1504 through the adapter body 1501, a spring 1505, and a latch 1503, with the ends of the pin 1504 resting in side wall holes 1519a, 1519b of the adapter body 1501. During insertion of the pin, the spring legs 1507 are positioned under the adapter body lip 1527, the central spring arm 1535 is rotated inward, the latch 1503 is positioned such that latch hole 1509 is positioned between the spring coils 1506a, 1506b and the central spring arm 1535 rests in the latch top notch 1533, with the pin being inserted through a side wall pinhole 1519a, a first spring coil 1506a, the latch hole 1509, a second spring coil 1506b, and the other side wall pinhole 1519b. The adapter body lip 1527 acts as a stopper for the spring legs 1507 such that the spring 1505 can be angularly displaced, biasing the latch to press against an end of an S-hook on which the locking adapter 1500 is installed. After positioning the locking adapter 1500 onto an S-hook, the locking adapter may be further secured to the S-hook by passing a bolt 1529 through the adapter body 1501 and threading into a nut 1528 that is held in a molded holder 1531 for securing a nut 1528, such as a hex locknut, wherein the molded holder 1531 and a side wall of the adapter body 1501, such as right side wall 1514b, are a monolithic body. In an embodiment, the adapter body 1501 may also be configured to have the molded holder 1531 built into a left side wall. The adapter body 1501 may also comprise raised ridges 1518 on the interior surface of the walls of the adapter body 1501 to help secure the locking adapter 1500 to an S-hook.

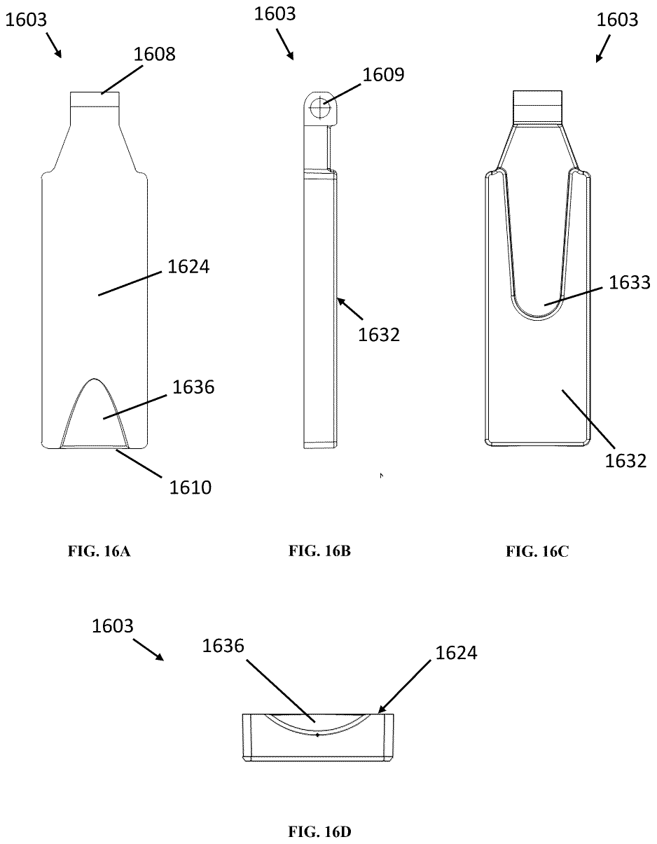

FIGS. 16A-16D illustrate views of an alternate embodiment of a latch of a locking adapter for an S-hook, according to an aspect. In an embodiment, latches of different sizes may be used in order to configure a locking adapter to be used with S-hooks of different sizes. FIG. 16A is a bottom view of a long latch 1603 showing the latch bottom surface 1624 and indicating a latch pivot end 1608 (comprising a latch hole 1609 seen in FIG. 16B) and a latch free end 1610 which rests against a free S-hook end of an S-hook. In an embodiment, the latch bottom surface 1624 may comprise a curved notch 1636 which helps to secure the long latch 1603 from slipping from its resting position against an S-hook. FIG. 16B is a side view of the long latch 1603 showing the latch hole 1609 for holding a pin which secures the long latch 1603 to an adapter body. FIG. 16C is a top view of the long latch 1603 showing a top notch or cavity 1633 formed in the top latch surface 1632 of the long latch 1603. As seen in FIGS. 16A-16C, the long latch 1603 may be sized to rest against the end of a taller S-hook, for example S-hook 522b seen in FIG. 5B. The long latch 1603 may also be configured such that a long latch pivot end 1608 connecting to an adapter body is substantially the same as a short latch pivot end 1208 of the short latch 1203 (seen in FIG. 12A-12C), allowing the long latch 1603 to be used with the same adapter body 1101 (seen in FIG. 11A-11F). FIG. 16D is a front end view of the long latch 1603 showing another view of the curved cavity 1636.

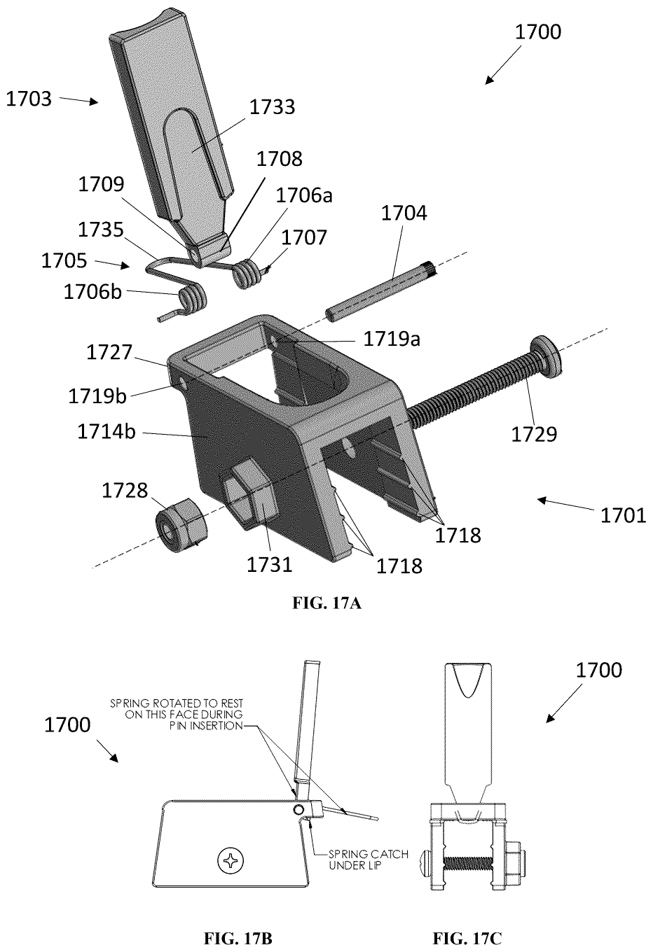

FIGS. 17A-17C illustrate the assembly of a locking adapter 1700 for an S-hook with a long latch 1703, according to an aspect. In an embodiment, the latch pivot end 1708 connecting to an adapter body 1701 is substantially the same as the latch pivot end 1508 of the shorter latch 1503 seen in FIG. 15A, and therefore the assembly of the locking adapter 1700 using the longer latch 1703 is substantially the same as described above for latch 1503. The length of the long latch 1703 may be different, allowing the locking adapter 1700 to be used with S-hooks of different sizes by using latches of different lengths. FIG. 17A illustrates an exploded view of the locking adapter 1700 showing the assembly of the locking adapter 1700, and FIGS. 17B-17C illustrate the rotation of the central spring arm 1735 during pin insertion such that the central spring arm 1735 rests in a latch top notch 1733 of a latch 1703 after assembly of the locking adapter 1700. In an embodiment, a long latch 1703 is secured to an adapter body 1701 by passing a pin 1704 through the adapter body 1701, a spring 1705, and the long latch 1703, with the ends of the pin 1704 resting in side wall holes 1719a, 1719b of the adapter body 1701. During insertion of the pin 1704, the spring legs 1707 are positioned under the adapter body lip 1727, the central spring arm 1735 is rotated inward, the long latch 1703 is positioned such that latch hole 1709 is positioned between the spring coils 1706a, 1706b and the central spring arm 1735 rests in the latch top notch 1733, and the pin is then inserted through a side wall hole 1719a, a first spring coil 1706a, the latch hole 1709, a second spring coil 1706b, and the other side wall hole 1719b.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A locking adapter for use with an S-hook, the locking adapter comprising:
an adapter body having:
a left pinhole in a left side wall;
a right pinhole in a right side wall opposite the left pinhole; and
a top wall connecting the left side wall and the right side wall;
wherein the top wall comprises an opening configured to receive a free end of the S-hook when the adapter is mounted to the S-hook; and
wherein the bottom of the left side wall and the bottom of the right side wall are wider than the top of the left side wall and the top of the right side wall to conform to a bottom portion of the S-hook;
a latch having:
a flat rectangular shape;
a first latch end;
a second latch end opposite the first latch end; and
a latch pinhole at the first latch end;
a spring having:
a spring arm;
a first spring leg;
a second spring leg; and
at least one spring coil; and
a pin;
wherein the pin is configured to be received into the spring coil and the latch pinhole, and wherein a first pin end is configured to be received into the left pinhole and a second pin end is configured to be received into the right pinhole of the body such that the latch is pivotally attached to the adapter body;
wherein the first spring leg and the second spring leg rest against the adapter body;
wherein the spring arm is configured to press against the latch, causing the latch to be biased towards a locked position;
wherein in the locked position the second latch end rests against the free end of the S-hook, forming a closed loop with the end of the S-hook;
wherein the spring allows the second latch end to be moved to an unlocked position; and
wherein in the unlocked position the second latch end is positioned away from the free end of the S-hook when a force is applied to the latch to open the S-hook.

2. The locking adapter of claim 1, further comprising a lip extending out from a first end of the body, wherein the left pinhole and the right pinhole are located at the first end of the adapter body, and wherein the lip is configured to act as a stop to limit the rotational range of motion of the latch.

3. The locking adapter of claim 2, wherein the lip is configured to retain the first spring leg and the second spring leg against a bottom surface of the lip.

4. The locking adapter of claim 1, further comprising a through hole in each of the left side wall and the right side wall, wherein the through holes are aligned with each other and configured to receive a bolt, and wherein the locking adapter is configured to be secured to the S-hook when the bolt is fastened to the locking adapter.

5. The locking adapter of claim 4, further comprising a molded holder on the left side wall of the adapter body or the right side wall of the adapter body, wherein the molded holder is aligned with the through holes, and wherein the molded holder is configured to receive a nut configured to fasten to the bolt.

6. The locking adapter of claim 1, further comprising at least one raised ridge on an interior surface of the left side wall of the adapter body and at least one raised ridge on an interior surface of the right side wall of the adapter body, wherein the ridges help secure the locking adapter to the S-hook.

7. The locking adapter of claim 1, wherein the latch comprises a cavity configured to receive the spring arm.

8. The locking adapter of claim 1, wherein the locking adapter is configured to allow a first latch to be exchanged for a second latch having different dimensions;
wherein a first latch pivot end on the first latch is configured to be pivotally attached to the adapter body;
wherein a second latch pivot end on the second latch is configured to have the same dimensions as the first latch pivot end on the first latch such that it may be pivotally attached to the adapter body;
wherein the second latch is configured with a length that differs from the length of the first latch; and
wherein the locking adapter may be used with S-hooks of different sizes.

9. The locking adapter of claim 1 wherein the latch further comprises a concave curved edge at the second latch end, wherein the curved edge rests securely against the surface of the free end of the S-hook.

10. A locking adapter for use with an S-hook, the locking adapter comprising:
an adapter body having:
a left pinhole in a left side wall;
a right pinhole in a right side wall opposite the left pinhole; and
a central opening in a center of the body passing from a top surface to a bottom surface of the adapter body, wherein the central opening is configured to receive an end of the S-hook, and wherein the bottom surface is larger than the top surface to conform to the bottom portion of the S-hook;
a latch having:
a flat rectangular shape;
a first latch end;
a second latch end opposite the first latch end;
a latch pinhole at the first latch end;
a spring;
a pin;
wherein the pin is configured to be received into the latch pinhole and pin ends are configured to be received into the left pinhole and the right pinhole of the adapter body such that the latch is pivotally attached to the adapter body;
wherein the spring biases the latch towards a locked position;
wherein in the locked position the second latch end rests against the free end of the S-hook, forming a closed loop with the end of the S-hook;
wherein the spring allows the second latch end to be moved to an unlocked position; and
wherein in the unlocked position the second latch end is positioned away from the free end of the S-hook when a force is applied to the latch to open the S-hook.

11. The locking adapter of claim 10 wherein the left pinhole and right pinhole are at a first end of the adapter body, and wherein the adapter body comprises a cutout portion of a front wall at the first end of the adapter body to accommodate the first end of the latch.

12. The locking adapter of claim 10, further comprising a channel in the adapter body passing from a front surface to a back surface of the adapter body, wherein the channel is open along the bottom of the adapter body, and wherein the channel accommodates a bottom portion of the S-hook when the locking adapter is mounted to the S-hook.

13. The locking adapter of claim 10, further comprising at least one raised ridge on an interior surface of the left side wall of the adapter body and at least one raised ridge on an interior surface of the right side wall of the adapter body, wherein the ridges help secure the locking adapter to the S-hook.

14. The locking adapter of claim 10 wherein the latch further comprises a concave curved edge at the second latch end, wherein the curved edge rests securely against the surface of the free end of the S-hook.

15. A locking adapter for use with an S-hook, the locking adapter comprising:
an adapter body having:
a left side wall;
a right side wall; and
a central opening in a center of the adapter body passing from a top surface to a bottom surface of the adapter body, wherein the central opening is configured to receive a free end of the S-hook, and wherein the bottom surface is larger than the top surface to conform to the bottom portion of the S-hook;
a latch having:
a flat rectangular shape;
a first latch end; and
a second latch end opposite the first latch end; and
a spring engaged with the adapter body and with the latch;
wherein the latch is pivotally attached to the adapter body at the first latch end;
wherein the spring biases the latch towards a locked position;
wherein in the locked position the second latch end rests against the free end of the S-hook, forming a closed loop with the end of the S-hook;
wherein the spring allows the second latch end to be moved to an unlocked position; and
wherein in the unlocked position the second latch end is positioned away from the free end of the S-hook when a force is applied to the latch to open the S-hook.

16. The locking adapter of claim 15, further comprising at least one raised ridge on an interior surface of the left side wall of the adapter body and at least one raised ridge on an interior surface of the right side wall of the adapter body, wherein the ridges help secure the locking adapter to the S-hook.

17. The locking adapter of claim 15, further comprising a through hole in each of the left side wall and the right side wall, wherein the through holes are aligned with each other and configured to receive a bolt, wherein the locking adapter is configured to be secured to the S-hook when the bolt is fastened to the locking adapter.

18. The locking adapter of claim 17, further comprising a molded holder on the left side wall of the adapter body or the right side wall of the adapter body, wherein the molded holder is aligned with the through holes, wherein the molded holder is configured to receive a nut, and wherein the bolt is threaded into the nut to secure the S-hook.

19. The locking adapter of claim 15, wherein the locking adapter is configured to allow a first latch to be exchanged for a second latch having different dimensions;
wherein a first latch pivot end on the first latch is configured to be pivotally attached to the adapter body;
wherein a second latch pivot end on the second latch is configured to have the same dimensions as the first latch pivot end on the first latch such that it may be pivotally attached to the adapter body;
wherein the second latch is configured with a length that differs from the length of the first latch; and
wherein the locking adapter may be used with S-hooks of different sizes.

20. The locking adapter of claim 15 wherein the latch further comprises a concave curved edge at the second end, wherein the curved edge rests securely against the surface of the free end of the S-hook.
